(19) United States
(12) Patent Application Publication
(10) Pub. No.: US 2012/0191625 A1
(43) Pub. Date: Jul. 26, 2012

(54) MULTIMEDIA COMMUNICATION AND SUPPORT SYSTEM THAT CAN BE USED WORLDWIDE FOR ASSEMBLY, INSPECTION, MAINTENANCE, AND REPAIR ASSIGNMENTS IN TECHNICAL FACILITIES, AND METHOD

(76) Inventors: Frank Arndt, Berlin (DE); Hans-Gerd Brummel, Berlin (DE); Volker Heblinski, Glienicke (DE); Willi Paschmann, Berlin (DE); Christian Reimann, Bergkamen (DE); Holger Santelmann, Paderborn-Elsen (DE); Olaf Schmidt, Vogelsdorf (DE); Dietmar Weber, Berlin (DE)

(21) Appl. No.: 13/379,384

(22) PCT Filed: Jun. 22, 2010
(86) PCT No.: PCT/EP2010/058766

§ 371 Date: Apr. 10, 2012

(30) Foreign Application Priority Data
Jul. 6, 2009 (EP) 09008813.9

(51) Int. Cl. G06Q 10/00

(52) U.S. Cl. 705/345

(57) ABSTRACT

An apparatus for providing a fitter with multimedia support during assembly work in or on a technical facility is provided. Existing remote-controlled systems for supporting technicians on-site do not offer sufficient support possibilities. By means of the apparatus, which includes a competence center having different transmitters and receivers, and a computer on-site, which has a multimedia system for examination, the support is improved and considerably faster.

### CROSS REFERENCE TO RELATED APPLICATIONS

This application is the US National Stage of International Application No. PCT/EP2010/058766, filed Jun. 22, 2010 and claims the benefit thereof. The International Application claims the benefits of European Patent Office application No. 09008813. EP filed Jul. 6, 2009. All of the applications are incorporated by reference herein in their entirety.

### FIELD OF INVENTION

The invention relates to a multimedia communication and support system that can be used worldwide for assignments when assembling, inspecting, carrying out maintenance on or repairing technical facilities and to a method.

### BACKGROUND OF INVENTION

When assembling, inspecting, carrying out maintenance on or repairing technical facilities throughout the world, there is often a need for support from technical experts who might not be constantly on site or whose arrival could take too long.

### SUMMARY OF INVENTION

Therefore, the object of the invention is to solve the abovementioned problem.

The object is achieved by an apparatus and a method according to the claims.

The subclaims for the apparatus and the method list further advantageous measures which can be combined with one another in any desired manner in order to achieve further advantages.

### BRIEF DESCRIPTION OF THE DRAWINGS

In the drawings:

FIG. 1 diagrammatically shows an apparatus for such a multimedia system,

FIG. 2 shows a gas turbine of a technical facility.

The drawings and the descriptions present only exemplary embodiments of the invention.

### DETAILED DESCRIPTION OF INVENTION

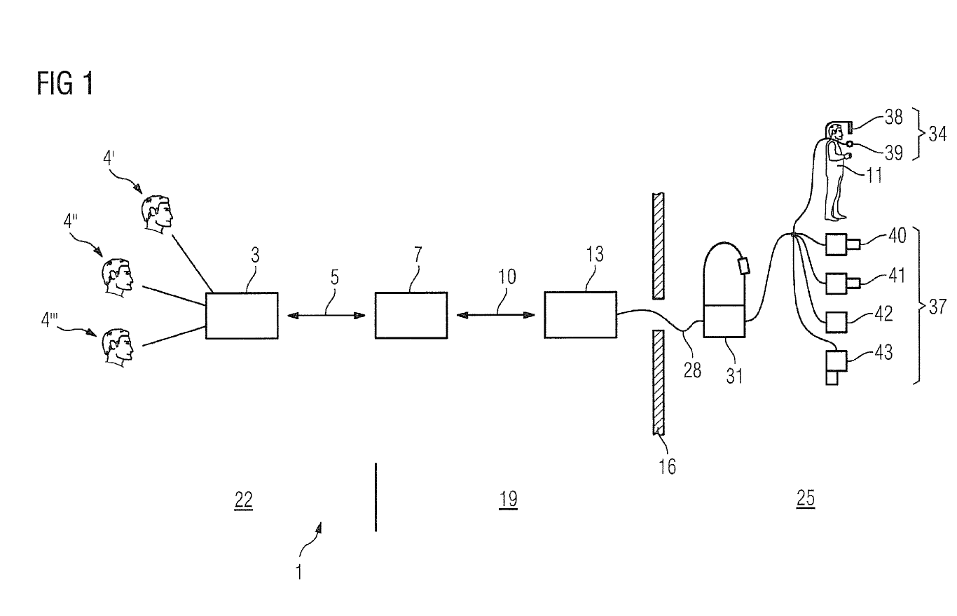

FIG. 1 shows an apparatus 1.

The apparatus 1 has a competence center 3 in the world 22 or a plurality of such competence centers 3 with at least one employee, in particular a plurality of employees, as specialists 4′, 4″, 4″' who examine complex machines and damage to machines 25 and can give instructions. These competence centers 3 can also interchange knowledge and experience with other specialists 4″, 4″' worldwide 22 directly at their workplaces outside the competence center 3 via all possible means of communication such as telephone, video, Internet etc. (not illustrated).

Information can be forwarded in bundled form from the preferably one competence center 3 via a global connection 5.

The technical prerequisites for networked communication (Internet, satellite communication etc.) for the global connection 5 are given in the competence centers 3.

Computers and large screens for following the work on the machine 25 are installed.

Communication with the fitter 11 on site, that is to say on the premises 19 or close to or in or on the machine 25, for example a gas turbine 100 on the premises 19—22 or the competence center 3 is not on the premises 19 or close to the machine 25—and where the above-described assembly, maintenance and repair work or else damage analyses and other activities requiring support are carried out, is achieved using a mobile main transmitter/receiver 7 for one or more of the following communication channels for the global connection 5 to the competence center 3:
satellite communication
Internet
secure, tunneled Internet connections
telephone
common remote service platform, secure Internet connection of the company.

The main transmitter/receiver 7 preferably has a satellite receiver/transmitter.

The method described here is not restricted to these listed communication possibilities but rather, on account of its modular structure, is also eminently suitable for using new communication methods which are in development or else completely new, future communication methods.

Communication via the global connection 5 is preferably effected using a global two-way connection.

The main transmitter/receiver 7 may be directly connected to the computer 31.

There is preferably a direct or a first local connection 10 to a further local transmitter/receiver 13 between the main transmitter/receiver 7 and a computer 31 (which is illustrated only on a relatively large scale in the drawing) carried by the fitter 11 on site 25.

The unit 13 is preferably connected to the main transmitter/receiver 7 in a wireless manner 10. Other connection technologies are conceivable.

There is a connection from the local transmitter/receiver 13 or from the main transmitter/receiver 7 to the computer 31. This connection may be effected in a wireless manner or by means of a second local connection 28 in the form of a wire line or other information conductors such as fiber optic cables, as a combination of radio and wire line or else by means of all other data connections which are able to penetrate metal enclosures. Use is thus also possible in metal industrial-scale containers, in particular in steam turbine housings or in combustion chambers in which wireless communication cannot be used.

The following prerequisites which differ considerably from standard computers are imposed on the computer 31 to be carried by the fitter 11:
compact, light design with secure connection contacts,
sufficient storage space for the documentation required during the work, such as assembly instructions, parts lists, test criteria, component number database etc.,
impact resistance, no movable parts,
operability using a special keyboard (see below for a description),
failsafe connection of all possible communication, analysis and operating components such as the operating keyboard, preferably integrated in a carrying strap, and all other mobile communication, operating, measuring and analysis devices in development and future mobile communication, operating, measuring and analysis devices.

A multimedia system 34 and an examination system 37, which is likewise illustrated on an enlarged scale in FIG. 1, are connected to the computer 31.

The multimedia system 34 has at least one of the following elements: microphone and headphones 39, data glasses with a head-up display 38.

The employees 4′, 4″, . . . simultaneously track the actions of the fitter 11 by means of a camera which is preferably provided in the head-up display 38.

The fitter is also in constant contact with the competence center 3 via the microphone 39 and headphones 39.

This special glasses combination can be integrated in a commercially available assembly safety helmet or else in a special hood if the safety helmet cannot be worn on site in the case of restricted space conditions. The computer display is integrated in the special glasses 38 and can be adjusted (focused) to the visual acuity of the operator. Either the surrounding area or the computer screen or possibly both can be perceived by moving the eye.

The examination system 37 has at least one of the following systems: a still camera 40, a boroscope 41, a video camera 42, an infrared camera 43 and/or a light source. Other examination devices or treatment devices such as lasers are conceivable.

All information such as images or films can be directly forwarded to the competence center 3 and/or can also be generally stored on the computer 31 or can be stored in the computer 31 as specified by the fitter 11.

The images can likewise be processed on site by the fitter 11 by virtue of the latter marking particular locations in the image or adding text or speech to a film which is then forwarded only in this faun, or in a form processed in any way, to the competence center 3.

The competence center 3 may likewise supply the fitter 11 with technical documents which are stored by the fitter 11 on the computer 31 and/or which can be viewed by the fitter 11 on the screen/head-up display 38.

The computer 31 is preferably, but not necessarily, carried on the body in an impact-resistant shoulder bag. The wiring is preferably, but not necessarily, integrated in the buckling-on belt or carrying strap.

Since the device 31, 34, 37 is also intended to be used for work in spaces which are difficult to access, such as gas turbine combustion chambers, the entire equipment is configured in such a manner that no parts can become detached and can fall into inaccessible regions of the machine (suitability for use for rotating machines).

In order to provide the fitter 11 on site 25 with the best prerequisites for both holding on and working and also maintaining communication with the outside in the process, particular requirements are imposed on the operating keyboard of the computer. For this purpose, provision is made of a one-hand operating means which is simple to operate and is preferably integrated in the carrying strap structure of the computer but in future can also be effected using voice or other innovative operating techniques.

The apparatus 1 makes it possible for the fitter 11 on site 19, 25 to use a portable computer 31 to directly contact an expert 4′, 4″ and resolve difficult situations without delay in real time. For this purpose, the apparatus 1 provides a number of further communication possibilities in addition to a voice connection. For example, the fitter 11 can send recordings of the findings in the form of video sequences or high-resolution individual images to the expert 4′, 4″. The expert 4′, 4″ in turn can send data sheets or required documents which are displayed to the fitter 11. In particular, the employee 4′, 4″ has the opportunity to provide these documents or the received recordings of the findings with annotations before sending, which considerably simplifies communication. When implementing this system for practical use, it is necessary to implement a multiplicity of requirements, The system on site is:
robust enough for industrial use
can be used without a large amount of training and, if possible, is language-independent
does not presuppose any infrastructure (apart from a power supply)
transmits the data in encrypted form and
can be exported to as many countries as possible.

In order to meet these central requirements, the apparatus 1 is subdivided into three subsystems.

The back-office system is used by the employee 4′, 4″ to communicate with the fitter 11 on site 19, 25.

The infrastructure system is on site 19, 25 in the vicinity of the fitter 11 and provides the latter with the necessary technical communication channels.

The fitter 11 himself mainly uses the mobile system (31, 34, 37) which he carries during the work.

One of the central requirements when developing the apparatus 1 was to be independent of the infrastructure available on site 19, 25. The infrastructure system which provides the necessary communication channels on site 19, 25 was created for this reason.

For the purpose of transmitting data, a WLAN connection is preferably provided for communication with the mobile system 31, 34, 37 associated with the fitter 11, and a separate DECT connection is preferably provided for voice communication. The connection to the Internet and thus ultimately to the employee 4′, 4″ is preferably effected by means of an integrated satellite modem. All parts of the infrastructure system are integrated in a transport rack and can preferably be operated using a standard interface (for example with a central multi-region power supply with overvoltage protection). In addition, the mobile system is completely stowed in the rack for transport.

The mobile system 31, 34, 37 is carried by the fitter 11 on site during the work and was specifically developed for the requirements imposed on the apparatus 1. For this purpose, a portable computer 31 including the full wiring of the peripherals was integrated in a specially produced bag. A head-up display 38 which is suitable for industrial use and is preferably fastened to the helmet is preferably used as the monitor. Two different camera systems can be used to record the findings. One simple camera on the helmet makes it possible to transmit videos, while a high-resolution camera which is accommodated in the bag when not in use allows detailed recordings of the findings. No mouse or computer keyboard is preferably needed for complete operation of the system. Instead, separate specialized keys are used for the respective functions.

The back-office system serves the employee 4′, 4″ to provide the fitter 11 on site with support. In this case, a tablet PC was preferably selected as the technical basis since it makes it possible, in particular, to create annotations in a particularly intuitive manner using the pen for interaction. The back-office system can be used by the employee 4′, 4″ to receive recordings of the findings from the engineer, to load existing documents, to make annotations (in documents and recordings of the findings) and to send them to the engineer. He can additionally send short text messages and a number of simple symbols.

Some examples for using the described apparatus 1:

### EXAMPLE 1

Providing an Engineer on Site with Support.

The fitter 11 on site 19, 25 is provided with parts of the above-described apparatus 1. He can use a camera 40, 42 to record both video sequences and individual high-resolution images of parts of the facility of interest. These images and sequences are forwarded in quasi real time to one or more experts 4′, 4″ scattered throughout the world via a satellite connection and can be sent back by said experts, in a form provided with corresponding written comments (annotations), or else can be orally commented on. The experts 4′, 4″ can also give instructions for the further course of work, thus making it possible to provide considerable support for the work of the fitter 11 on site 19, 25. All recorded and received data and images are directly projected into the field of view of the fitter 11 via the data glasses on the helmet belonging to the fitter.

### EXAMPLE 2

Inspection of Parts with Release for their Further Use.

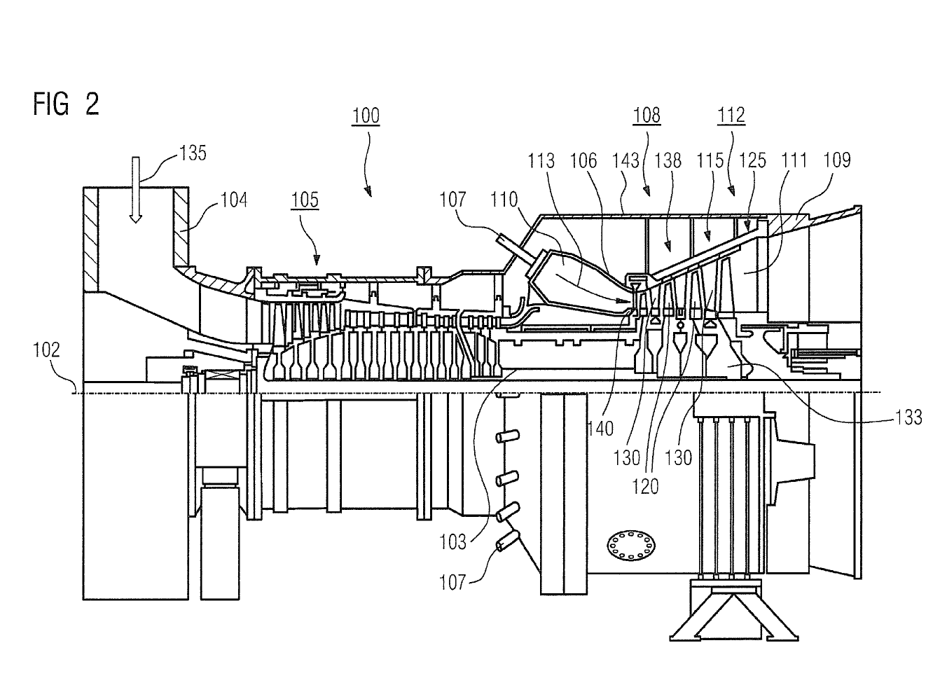

Ceramic heat shields (tiles) in combustion chambers of stationary gas turbines 100 (FIG. 2) must be periodically inspected on account of the changing load. However, the tile need not be replaced each time a crack is detected, which is time-consuming and cost-intensive. Depending on the installation location and position of the cracks, there are critical crack sizes below which the heat shield tile does not need to be replaced. On account of the high potential risk for the downstream turbine blades 120, 130 which is posed by tiles which become detached, there is a need here for specially trained experts 4′, 4″ who make the decision on whether or not the tile should be replaced. Since there are only a few experts 4′, 4″ throughout the world, there are often staff shortages or time delays for these inspections. The new interactive communication, documentation and support system 1 makes it possible to carry out these inspections and, in particular, to make the decision on which tiles need to be replaced in a considerably more efficient manner using this innovative system. On account of the metal housings of the turbines 100, a flexible wire connection (also possibly in the form of an optical fiber connection for data transfer) is needed in this case from the place of work to a terminal point outside the machine, from which the data/information can be forwarded by radio from then on.

Further applications are desired/actual comparison of machine components, part identification/documentation of part replacement actions, measuring, database input directly on the machine without manual intermediate logging in paper lists or notepads which is prone to error, for example when replacing turbine blades 120, 130.

The described infrastructure and the associated equipment therefore make it possible for specialists 4′, 4″ to directly supervise critical assignments on site 19, 25 online, to guide said assignments or else to decide on whether parts still meet the requirements or have to be replaced. The apparatus 1 differs from other applications, for example in the military sector, by virtue of the fact that it is specifically designed for use in metal enclosures such as turbine housings, steam generator drums etc. where conventional wireless systems cannot be used. The design of the computer 31 and of the other equipment is specifically tailored to use in these apparatuses and machines 25.

FIG. 2 shows, by way of example, a partial longitudinal section through a gas turbine 100.

The gas turbine 100 has, in the interior, a rotor 103 which is rotatably mounted around an axis of rotation 102, has a shaft 101 and is also referred to as the turbine rotor.

An intake housing 104, a compressor 105, a combustion chamber 110, for example a torus-like combustion chamber, in particular an annular combustion chamber, having a plurality of coaxially arranged burners 107, a turbine 108 and the exhaust gas housing 109 follow one another along the rotor 103.

The annular combustion chamber 110 communicates with a hot gas passage 111 which is annular, for example. For example, four turbine stages 112 which are connected in series form the turbine 108 there.

Each turbine stage 112 is formed from two blade rings, for example. A row 125 formed from moving blades 120 follows a row of guide blades 115 in the hot gas passage 111, seen in the direction of flow of a working medium 113.

In this case, the guide blades 130 are fastened to an inner housing 138 of a stator 143, whereas the moving blades 120 in a row 125 are fitted to the rotor 103, for example by means of a turbine disk 133.

A generator or a working machine (not illustrated) is coupled to the rotor 103.

During operation of the gas turbine 100, the compressor 105 draws in air 135 through the intake housing 104 and compresses it. The compressed air provided at the turbine-side end of the compressor 105 is passed to the burners 107 and is mixed with a fuel there. The mixture is then burnt in the combustion chamber 110 so as to form the working medium 113. From there, the working medium 113 flows along the hot gas passage 111 past the guide blades 130 and the moving blades 120. The working medium 113 expands at the moving blades 120, transmitting its momentum, with the result that the moving blades 120 drive the rotor 103 and the latter drives the working machine coupled to it.

The parts exposed to the hot working medium 113 are subject to thermal loads during operation of the gas turbine 100. The guide blades 130 and moving blades 120 of the first turbine stage 112, as seen in the direction of flow of the working medium 113, are subject to the highest thermal loading apart from the heat shield elements lining the annular combustion chamber 110.

In order to withstand the temperatures prevailing there, they may be cooled using a coolant.

Substrates of the parts may likewise have a directed structure, that is to say they are monocrystalline (SX structure) or have only longitudinally directed grains (DS structure).

Iron-based, nickel-based or cobalt-based superalloys are used, for example, as the material for the parts, in particular for the turbine blades 120, 130, and parts of the combustion chamber 110.

By way of example, such superalloys are known from EP 1 204 776 B1, EP 1 306 454, EP 1 319 729 A1, WO 99/67435 or WO 00/44949.

The blades 120, 130 may also have coatings protecting them from corrosion (MCrAlX; M is at least one element selected from the group consisting of iron (Fe), cobalt (Co), Nickel (Ni), X is an active element and represents yttrium (Y) and/or silicon, scandium (Sc) and/or at least one rare earth or hafnium). Such alloys are known from EP 0 486 489 B1, EP 0 786 017 B1, EP 0 412 397 B1 or EP 1 306 454 A1.

There may also be a thermal barrier coating on the MCrAlX, which coating consists, for example, of ZrO₂, Y₂O₃—ZrO₂, i.e. it is not stabilized, is partially stabilized or is completely stabilized by yttrium oxide and/or calcium oxide and/or magnesium oxide.

Columnar grains are produced in the thermal barrier coating by suitable coating processes, such as electron beam physical vapor deposition (EB-PVD).

The guide blade 130 has a guide blade root (not illustrated here) facing the inner housing 138 of the turbine 108 and a guide blade head opposite the guide blade root. The guide blade head faces the rotor 103 and is fixed to a fastening ring 140 of the stator 143.

1-18. (canceled)

19. An apparatus for providing a fitter with multimedia support during assembly work in or on a technical facility, the apparatus comprising:
a stationary competence center somewhere in the world in which competence center at least one employee works;
a global connection between the competence center and a main transmitter/receiver close to or in the technical facility;
a first local connection between the main transmitter/receiver and a local transmitter/receiver, which is arranged closer to the technical facility on which maintenance is to be carried out;
a second local connection between the local transmitter/receiver and a portable computer;
a multimedia system; and
an examination system,
wherein the multimedia system and the examination system may be carried and used by the fitter in the technical facility.

20. The apparatus as claimed in claim 19, wherein the global connection is effected via satellite, Internet or telephone connections.

21. The apparatus as claimed in claim 19, wherein the first local connection between the main transmitter/receiver and the local transmitter/receiver is effected by means of a wireless connection.

22. The apparatus as claimed in claim 19, wherein the main transmitter/receiver is directly connected to the computer.

23. The apparatus as claimed in claim 19, wherein the second local connection between the local transmitter/receiver and the computer or between the main transmitter/receiver and the computer is effected by means of a cable.

24. The apparatus as claimed in claim 19, wherein a barrier is present between the main transmitter/receiver or the local transmitter/receiver and the computer.

25. The apparatus as claimed in claim 19, wherein the multimedia system used by the fitter on site is connected to the computer.

26. The apparatus as claimed in claim 19, wherein which multimedia system includes an element selected from the group consisting of a microphone and headphones, a head-up display with a camera, and a combination of both.

27. The apparatus as claimed in claim 19, wherein the examination system includes an element selected from the group consisting of a still camera, a boroscope, a video camera, an infrared camera, a light source, and a combination thereof.

28. The apparatus as claimed in claim 19, wherein the main transmitter/receiver is mobile.

29. The apparatus as claimed in claim 19, wherein the apparatus includes only one main transmitter/receiver on site.

30. The apparatus as claimed in claim 19, wherein the apparatus includes only one local transmitter/receiver on site.

31. The apparatus as claimed in claim 27, wherein there is a direct connection from the competence center to the examination system.

32. The apparatus as claimed in claim 31, wherein the examination system includes the still camera or the video camera with the result that videos or photographs are directly tracked in the competence center.

33. The apparatus as claimed in claim 26, wherein there is a direct connection from the competence center to the multimedia system.

34. The apparatus as claimed in claim 33, wherein the direct connection is to headphones and the microphone and/or to the head-up display and/or to the camera with the result that the view and actions of the fitter are directly tracked in the competence center.

35. A method for assembling a facility, comprising:
communicating between a fitter in a region of the facility and experts in a remote competence center using an apparatus comprising:
a stationary competence center somewhere in the world in which competence center at least one employee works;
a global connection between the at competence center and a main transmitter/receiver close to or in the technical facility;
a first local connection between the main transmitter/receiver and a local transmitter/receiver, which is arranged closer to the technical facility on which maintenance is to be carried out;
a second local connection between the local transmitter/receiver and a portable computer;
a multimedia system; and
an examination system,
wherein the multimedia system and the examination system may be carried and used by the fitter in the technical facility.

36. The method as claimed in claim 35,
wherein the fitter takes photographs of the facility, and
wherein the photographs are stored in the computer and/or are sent to the competence center.

37. The method as claimed in claim 35, wherein each photograph of the facility is electronically marked by the fitter and is then sent to the competence center.

38. The method as claimed in claim 35, wherein the employees send technical documents to the fitter to the computer or for inspection depending on the requirement.
